(19) United States
(12) Patent Application Publication
(10) Pub. No.: US 2005/0185634 A1
(43) Pub. Date: Aug. 25, 2005

(54) Method and system for providing network support for messaging between short message service (SMS) subscribers and instant messaging (IM) subscribers

(76) Inventors: David S. Benco, Winfield, IL (US); Sandra Lynn True, St. Charles, IL (US)

Correspondence Address: Richard J. Minnich, Esq.;Fay, Sharpe, Fagan, Minnich & McKee, LLP, 1100 Superior Avenue, Seventh Floor, Cleveland, OH, 44114-2518, US

(21) Appl. No.: 10/785,647

(22) Filed: Feb. 24, 2004

(51) Int. Cl. H04L 12/66

(52) U.S. Cl. 370/352

(57) ABSTRACT

This invention relates to a method and system for providing network support for messaging between short message service (SMS) subscribers and instant messaging (IM) subscribers. More particularly, the present invention provides a system for SMS and IM users to exchange messages directly. According to the present invention, IM users have access to the mobile subscriber community via mobility gateways and SMS users have access to the IM community via public data networks.

### BACKGROUND OF THE INVENTION

This invention relates to a method and system for providing network support for messaging between short message service (SMS) subscribers and instant messaging (IM) subscribers. More particularly, the present invention provides a system for SMS users and IM users to exchange messages directly. According to an embodiment of the present invention, IM users have access to the mobile subscriber community via mobility gateways and SMS users have access to the IM community via public data networks. It is this access that allows for the exchange of messages between the heretofore segregated systems.

While the invention is particularly directed to the art of messaging between SMS subscribers and IM subscribers, and will be thus described with specific reference thereto, it will be appreciated that the invention may have usefulness in other fields and applications. For example, the invention may be used in other applications where messages having different formats are sought to be communicated between entities.

By way of background, short message service (SMS) provides mobile subscribers with an alternative manner in which to communicate to other mobile subscribers when voice communication is not practical. For example, SMS messaging is often used by a subscriber to communicate with another subscriber who is in a meeting or conference and, thus, is unable to engage in a voice call. Notably, SMS messages are provided over the traditional voice networks, e.g., the wireless and landline phone networks.

The popularity of SMS has grown enormously in recent years, and continues to grow. It is believed that billions of SMS messages are transmitted worldwide each month.

Similarly, instant messaging (IM) has become an important business tool by which business associates may engage in “chat” sessions. In addition, it is used extensively for personal “chat” sessions. Chat sessions allow for an ongoing and interactive written, or textual, dialogue between two parties who subscribe to the instant messaging (IM) service. Notably, IM messages are provided between users over the more traditional data networks, e.g., the internet.

A limitation of SMS and IM, however, is that neither technology currently bridges the separation between the traditional voice and data networks. As a result, two relatively large and growing communities of users, i.e., SMS users and IM users, are unable to communicate directly with one another.

Along these lines, it is typical for people to have access to a mobile handset (e.g., to send an SMS message) or a personal computer (e.g., to send an IM message) at any given time. However, it is not often that a person has access to both a mobile device and a computer at the same time. Therefore, it would be desirable to have a network solution for allowing SMS users and IM users to exchange messages directly.

The present invention contemplates a new and improved technique that resolves the above-referenced difficulties and others.

### SUMMARY OF THE INVENTION

A method and apparatus for providing network support for messaging between short message service (SMS) subscribers and instant messaging (IM) subscribers are provided.

In one aspect of the invention, the system comprises a first network element including a first destination parser module operative to analyze first destination data of an SMS message to determine if the first destination data is a telephone number and, if the first destination data is not a telephone number, processing the SMS message for transmission through a gateway for a data network and a second network element including a second destination parser module operative to analyze second destination data of an IM message to determine if the second destination data is an e-mail address and, if the second destination data is not an e-mail address, processing the IM message for transmission through a gateway for a wireless network.

In another aspect of the invention, the first network element is a switching element.

In another aspect of the invention, the switching element is a mobile switching center.

In another aspect of the invention, the second network element is a router.

In another aspect of the invention, the first network element further includes a protocol converter operative to process the first message for transmission through the gateway for the data network.

In another aspect of the invention, the second network element further comprises a protocol converter for processing the IM message for transmission through the gateway for the wireless network.

In another aspect of the invention, the first network element is operative to process the SMS message for transmission through the wireless network if the destination data is a telephone number.

In another aspect of the invention, the second network element is operative to process the IM message for transmission through the data network if the second destination data is an e-mail address.

In another aspect of the invention, the method comprises steps of receiving an SMS message having destination data included therein, analyzing the destination data to determine if the destination data is a telephone number and processing the SMS message for transmission through a gateway for a data network if the destination data is not a telephone number.

In another aspect of the invention, the method further comprises processing the SMS message for transmission through a gateway for a wireless network if the destination data is a telephone number.

In another aspect of the invention, the method comprises steps of receiving an IM message having destination data included within, analyzing the destination data to determine if the destination data is an e-mail address and processing the IM message for transmission through a gateway for a wireless network if the destination data is not an e-mail address.

In another aspect of the invention, the method further comprises processing the IM message for transmission through a gateway for a data network if the destination data is an e-mail address.

In another aspect of the invention, the system comprises means for receiving an SMS message having destination data included therein, means for analyzing the destination data to determine if the destination data is a telephone number and means for processing the SMS message for transmission through a gateway for a data network if the destination data is not a telephone number.

In another aspect of the invention, the system further comprising means for processing the SMS message for transmission through a gateway for a wireless network if the destination data is a telephone number.

In another aspect of the invention, the system comprises means for receiving an IM message having destination data included within, means for analyzing the destination data to determine if the destination data is an e-mail address and means for processing the IM message for transmission through a gateway for a wireless network if the destination data is not an e-mail address.

In another aspect of the invention, the system further comprises means for processing the IM message for transmission through a gateway for a data network if the destination data is an e-mail address.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a network into which the present invention is incorporated;

FIG. 2 is a flow chart illustrating a method according to the present invention;

FIG. 3 is a flow chart illustrating a method according to the present invention;

FIG. 4 is an illustration of a portion of the network of FIG. 1 in accordance with the present invention;

FIG. 5 is an illustration of a portion of the network of FIG. 1 in accordance with the present invention;

FIG. 6 is a call flow diagram illustrating an implementation of the present invention; and,

FIG. 7 is a call flow diagram illustrating an implementation of the present invention.

### DETAILED DESCRIPTION OF THE PREFERRED EMBODIMENTS

The present invention provides network support for messaging between short message service (SMS) subscribers and instant messaging (IM) subscribers. Both messaging technologies are similar in that they offer a convenient manner in which to communicate via short, text-based messages. Moreover, graphic support is minimal. However, as noted above, neither technology allows for a bridging between the technologies.

In an embodiment of the present invention, IM users, or subscribers, are provided access to a mobile subscriber community (a community to which an IM subscriber would typically not have access through an IM service) via mobility gateways. In addition, SMS users are provided access to the IM community (a community to which an SMS subscriber would typically not have access through an SMS) via public data network gateways. In this manner, the messaging options for individual users are greatly enhanced.

More particularly, the present invention allows for network support for a messaging gateway between a voice-network messaging system (e.g., an SMS message system) and a data network messaging system (e.g., an IM system). To achieve this objective, a technique is implemented in the network to recognize an SMS message (typically transmitted only on a traditional voice network) intended for a user on a data network and to deliver the message to a port on a gateway for the data network. Moreover, the network is provided with the ability to receive an IM message (typically transmitted only on a traditional data network) and to deliver it to an intended mobile subscriber on a voice network.

From the perspective of the user, or subscriber, the process is relatively rudimentary. For example, to send an SMS message to any user, the originating subscribing user of a mobile device simply enters the destination mobile number (for a message to another mobile), or the destination e-mail address (for a message to a PC), as destination data in the appropriate location. Similarly, to send an IM message to any user, a subscribing IM user of a personal computer (PC) simply enters the intended recipient's e-mail address (for a message to be sent to another PC) or a destination mobile telephone number (for messages that are to be sent to a mobile handset).

The messages that are sent from a subscribing mobile user to another subscribing mobile user are handled by the network using conventional, known techniques. However, the messages that are sent from a subscribing mobile user to a subscribing IM user (or PC user) are routed by the network to an IP gateway for transmission to the intended PC user.

The messages that are sent from a subscribing IM user to another subscribing IM user are handled by the network using conventional, known techniques. However, the messages that are sent from a subscribing IM user to a subscribing mobile user are routed to a mobile network gateway for transmission to a short message service center (SMSC). Of course, as is known in the field, the message is ultimately then transmitted to the intended mobile handset.

A variety of practical and economic benefits are realized through implementation of the present invention. For example, mobile service providers can provide additional options to their users and, thus, grow revenue. In this regard, the present invention will provide increased usage of SMS messages by existing mobile subscribers who choose to send messages to an entirely new population of recipients. Also, mobile service providers will potentially gain revenue when PC users send messages to mobile SMS users. Internet service providers will benefit by extending the reach of IM services to their customers to encompass mobile users. Finally, both mobile subscribers and PC users will benefit by having a direct communication path between the two communities of users.

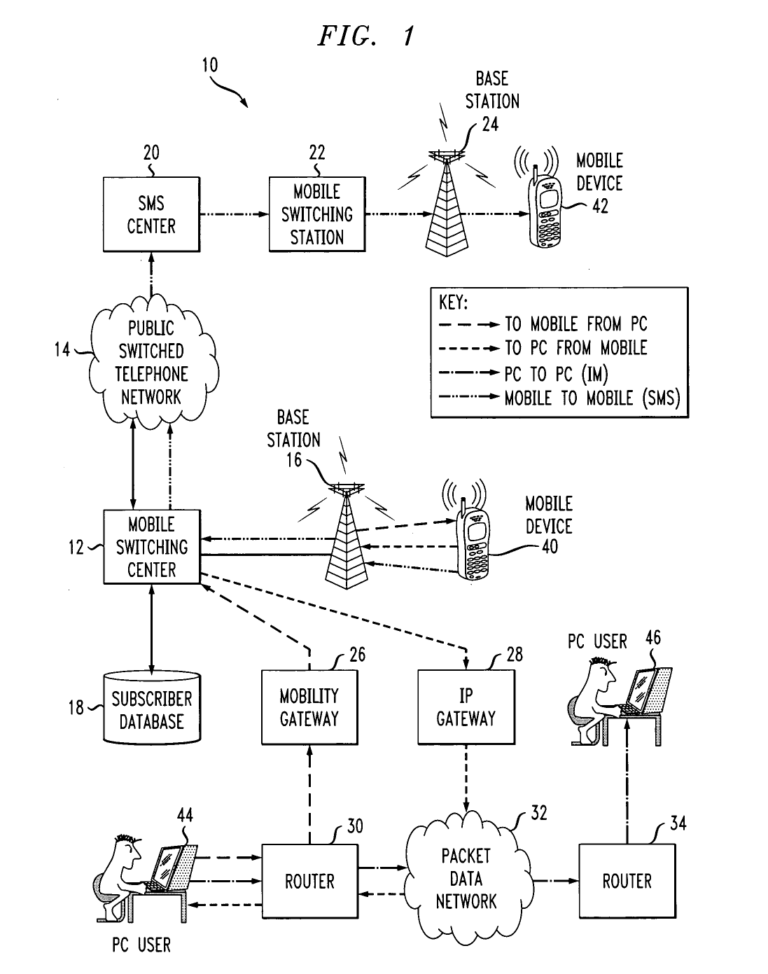

Referring now to the drawings wherein the showings are for purposes of illustrating the preferred embodiments of the invention only and not for purposes of limiting same, FIG. 1 provides a view of an exemplary network incorporating the present invention. As shown, a network 10 includes a mobile switching center 12 connected to a public switched telephone network (PSTN) 14, a base station 16, and a subscriber database 18. The public switched telephone network (PSTN) 14 is, in turn, connected to an SMS center 20, which is in communication with another mobile switching center 22. The mobile switching center 22 likewise communicates with a base station 24.

The mobile switching center (MSC) 12 is also connected to a mobility gateway 26 and an IP gateway 28. The mobility gateway 26 communicates with a router 30 and the IP gateway 28 communicates with a packet data network 32. In the embodiment shown, the packet data network 32 communicates with the router 30 as well as with a second router 34.

Also shown within the network are a variety of users. For example, a mobile subscriber having a mobile device 40 communicates with the base station 16. Likewise, a mobile subscriber having a mobile device 42 communicates with the base station 24. These mobile devices are illustrated as mobile phones but may take the form of any mobile device capable of sending SMS messages, e.g., personal digital assistants (PDAs), etc. As a further example, users or subscribers having personal computers (PCs) 44 and 46 are illustrated as communicating with routers 30 and 34, respectively. Further, as shown, personal computers are illustrated; however, any computing device capable of sending an IM message over a data network may be used.

In operation, the network deals with SMS messages and IM messages, which can both be referred to as destination data, according to their source (e.g., a mobile device or a personal computer) and destination (e.g., determined by the destination data such as a telephone number or an e-mail address). In this regard, for short message service between mobile devices, conventional techniques are used. As shown in FIG. 1, the mobile subscriber using mobile device 40 can send a short message to the mobile subscriber using the mobile device 42 via a communication path established through the base station 16, the mobile switching center 12, the public switched telephone network 14, the SMS center 20, the mobile switching center 22 and the base station 24. Likewise, instant messaging between a subscriber stationed at the PC 44 and a subscriber stationed at the PC 46 can be accomplished by using conventional techniques. In this regard, a communication path is established through the router 30, the packet data network 32 and the router 34.

Notably, the present invention is directed to providing a crossover between the instant messaging (IM) infrastructure and the short message service (SMS) infrastructure. In this regard, the mobile subscriber using the mobile device 40 may send an SMS message to a the PC user stationed at the computer 44 via a communication path established through the base station 16, the mobile switching center 12, the IP gateway 28, the packet data network 32 and the router 30. Similarly, the subscriber stationed at the PC 44 can send an instant message to a mobile device 40 by way of a communication path established through the router 30, the mobility gateway 26, the mobile switching center 12 and the base station 16.

Based on this functionality and configuration, it should be appreciated that, except as provided below, the network elements illustrated in FIG. 1 take forms that are presently well known in the art. Known alternatives to any of the elements may also suffice. For example, mobile switching centers are illustrated; however, any element having primary switching functions could be used. It should also be appreciated the network elements and the network configuration illustrated are merely exemplary. Any of a variety of elements and configurations that will be apparent to those skilled in the art may be used to accomplish the objectives of the invention.

It will be apparent, however, that the mobile switching center 12 and the router 30 will take modified form, as will be discussed in detail below. Moreover, the subscriber database 18 may require modification to provide data fields to accommodate the present invention. For example, data fields may be necessary to allow the network to verify that a particular user is a subscriber to services contemplated by the present invention.

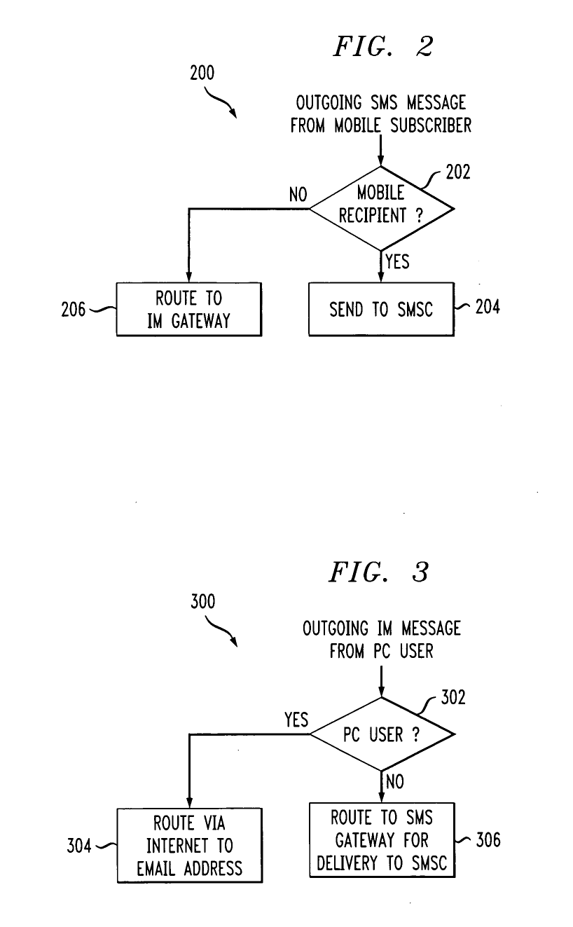

Referring now to FIG. 2, a method 200 is illustrated. The method 200 addresses the situation where an SMS message is transmitted from a mobile subscriber. The method is preferably implemented in the exemplary network within the mobile switching center 12. Various software techniques and hardware implementations can be used to so implement this method, the specific functionality of which will be described hereafter. Also, it should be understood that the mobile switching center may verify or authenticate that a user subscribes to the relevant service by accessing the subscriber database 18.

As to the method 200, a determination is first made whether the recipient of the SMS message is a mobile recipient (step 202). This is accomplished by analyzing the destination data that is received, typically included within the header information of the message. If the destination data is a mobile telephone number, the SMS message is simply forwarded to a serving mobile switching center, such as mobile switching center (MSC) 22 in FIG. 1, through the network (e.g., through the public switched telephone network (PSTN) 14 and SMS center 20) using conventional techniques (step 204). However, if the destination data is not a mobile telephone number, it is determined that the SMS message is not intended for a mobile recipient. As such, the message is ultimately routed to a data gateway, such as IP gateway 28 (step 206).

Referring now to FIG. 3, a method 300 is illustrated. The method 300 is a method preferably implemented in the exemplary network of FIG. 1 within the router 30. Again, method 300 may be implemented using a variety of software techniques and hardware implementations, the specific functionality of which will be described hereafter. In addition, the router 30 may be provided with a routine, similar to the MSC 12, to verify that a user subscribes to the service requested. It could accomplish this by accessing a database, for example.

As to the method 300, it addresses a situation where an outgoing IM message is transmitted from a PC, such as PC 44, of FIG. 1. Once the IM message is received at the router 30, a determination is made as to whether the recipient is a PC user (step 302). This is accomplished by analyzing the destination data, typically included within the header information of the message. If the destination data is an e-mail address (i.e. is intended for a PC user), the IM message is simply routed via conventional techniques to the destination e-mail address or subscribing PC user stationed at, for example, PC 46 (step 304). However, if the destination data is not an e-mail address, a determination is made that the destination data must be a mobile telephone number. Thus, it is determined that the intended recipient is a mobile recipient. In this case, the router 30 ultimately routes the IM message to the mobility gateway 26 for transmission to the mobile switching center 12 for further processing (step 306).

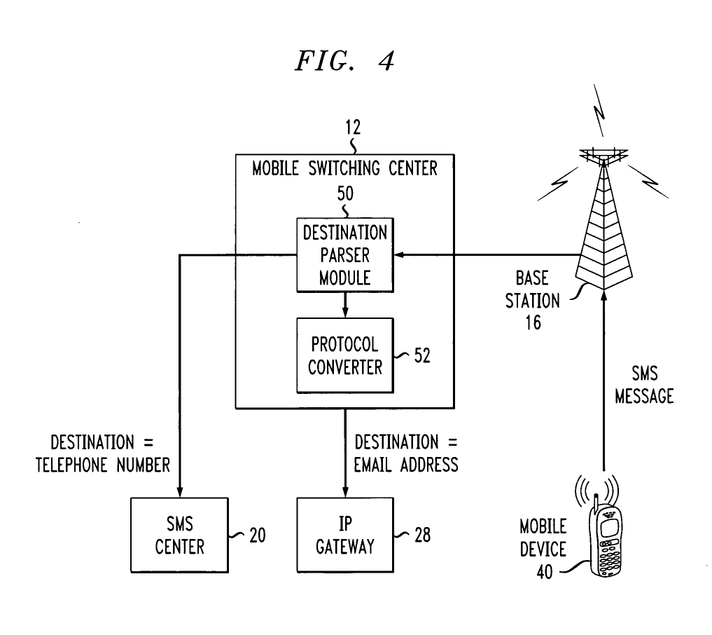

Referring now to FIG. 4, a configuration of the mobile switching center 12 according to the present invention is illustrated. Of course, it should be appreciated that the mobile switching center operates to provide a variety of services and functions to the network that are well known in the art and not shown in FIG. 4. For illustrative purposes and ease of understanding, FIG. 4 illustrates portions of the mobile switching center 12 that are used to implement the present invention.

More particularly, the mobile switching center 12 includes a destination parser module 50 and a protocol converter 52. The destination parser module 50 analyzes the destination data received with a call to determine if the destination is a mobile telephone, i.e. if the destination is a mobile telephone number. If so, the destination parser module 50 simply routes the call as is known, e.g. to the SMS center 20 through, for example, the public-switched telephone network (PSTN) 14. Recognizing a mobile phone number (e.g., a series of digits) is a functionality that is typically present in all mobile switching centers.

If, however, the destination parser module 50 does not recognize the destination data as a phone number, then it determines that the destination data must be an e-mail address and sends the data to the protocol converter 52. This portion of the process can be implemented by using a simple IF-THEN type routine that is well known in most programming languages. The protocol converter 52 then performs functions to place the destination data in appropriate format, according to established standards and data communication protocols, to be transmitted to the IP gateway 28, for example. It should be appreciated that if the destination data is not a suitable telephone number (or series of digits) or an appropriate e-mail address (e.g. contains an error), then the protocol converter 52 will fail in its operation and take appropriate action, such as generate an error message. The error message will, of course, be transmitted back to the user.

Also shown in FIG. 4 are other elements of the network such as the base station 16, the mobile subscriber 40, the IP gateway 28 and the SMS center 20. Communication between these elements is accomplished using conventional techniques.

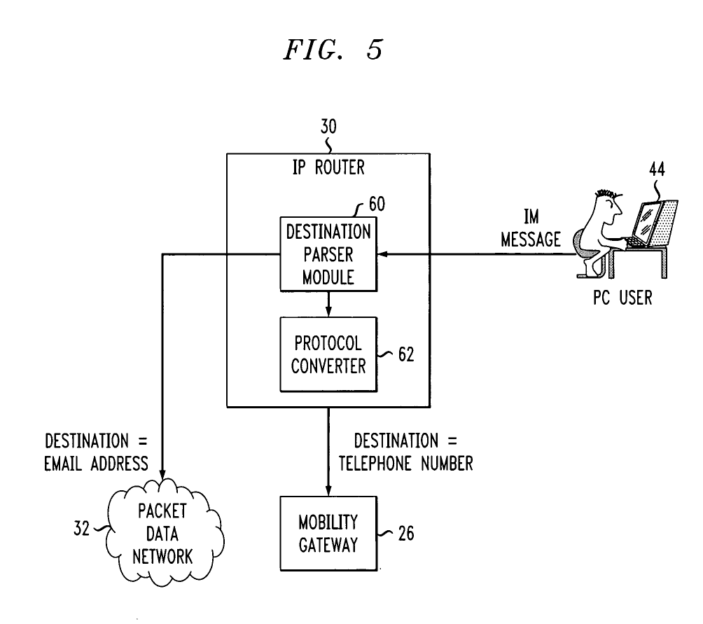

Referring now to FIG. 5, the IP router 30 is illustrated. Again, the IP router 30 includes a variety of elements necessary for performing conventional functions within the network which are well known in the art and not shown. However, elements of the IP router 30 used to implement the present invention are shown. In particular, the IP router 30 includes a destination parser module 60 and a protocol converter 62. The destination parser module 60 analyzes the destination data received with a call to determine if the destination is an e-mail address, i.e. if the destination is a PC. If so, the destination parser module 60 simply routes the call as is known, e.g. to the packet data network 32. Recognizing the destination data as an e-mail address is a functionality that is typically present in all IP-type routers.

If, however, the destination parser module 60 does not recognize the destination data as an e-mail address, then it determines that the destination data must be a mobile telephone number and sends the data to the protocol converter 62. This portion of the process can be implemented by using a simple IF-THEN type routine that is well known in most programming languages. The protocol converter 62 then performs functions to place the destination data in appropriate format, according to established standards and voice communication protocols, to be transmitted to the mobility gateway 26, for example. It should be appreciated that if the destination data is not a suitable telephone number or an appropriate e-mail address (e.g. contains an error), then the protocol converter 62 will fail in its operation and take appropriate action, such as generate an error message. The error message will, of course, be transmitted back to the user.

Of course, the IP router communicates with a variety of network elements. As illustrated, a PC user using a PC 44 sends an IM message to the IP router 30 and the IP router sends appropriate data either to the packet data network 32 or a mobility gateway 26.

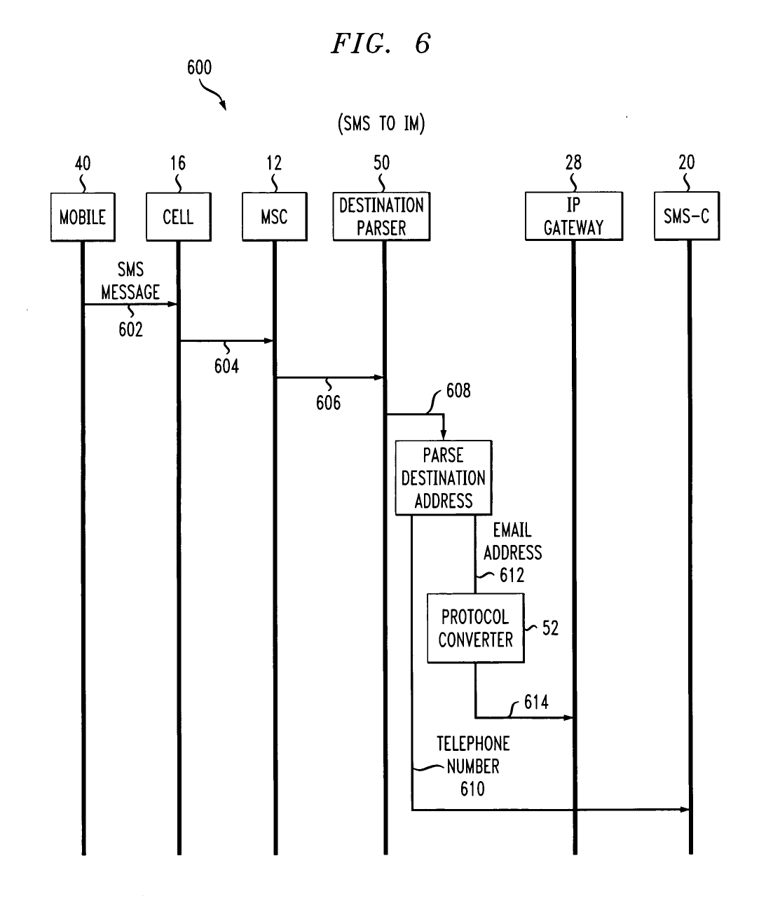

Referring now to FIG. 6, a call flow 600 is illustrated. As shown, a mobile subscriber, through the mobile device 40, sends an SMS message to the cell site 16 (at 602). The cell site 16 transmits the message to the MSC 12 (line 604). The MSC, in turn, processes the message by sending the message to the destination parser 50 (at 606). The destination parser then parses, or analyzes, the destination address (at 608). If the destination parser recognizes a telephone number, then the mobile telephone call is simply connected to the destination via conventional techniques (at 610). However, if a telephone number is not detected, the destination parser treats the data as an e-mail address, processes the data via protocol converter 52 and forwards the data on to the IP gateway (at 614).

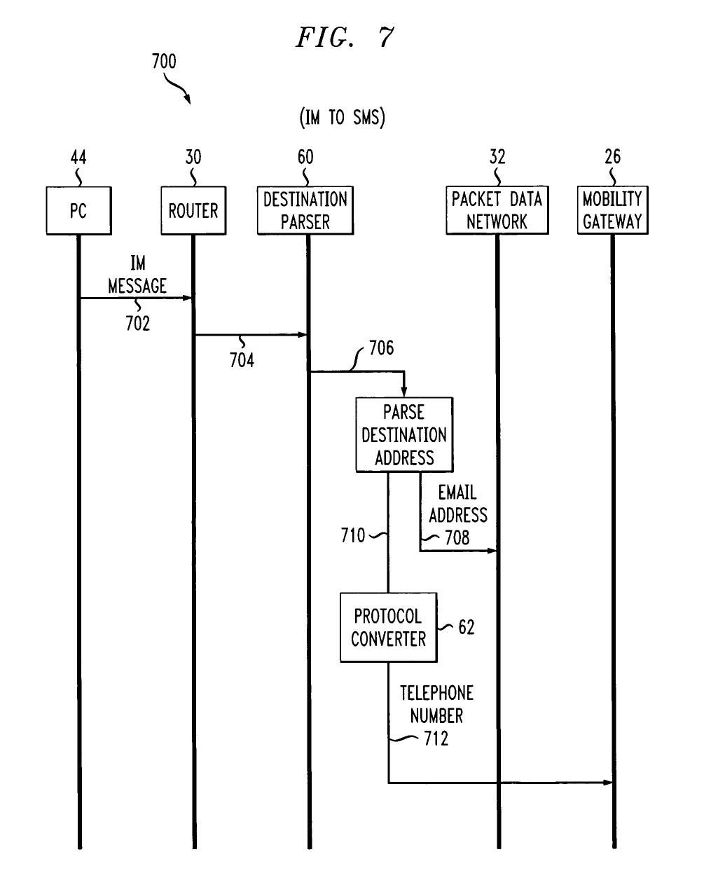

Referring now to FIG. 7, a call flow 700 is illustrated. In the call flow 700, an IM subscriber, through PC 44, sends an IM message to a router 30 (at 702). The router 30 routes the data to a destination parser 60 (at 704). The destination parser 60 then parses, or analyzes, the destination address (at 706). If the address is recognized as an e-mail address, the destination parser treats the message as is conventional in the art and forwards the data on to the packet data network 32 (at 708). However, if an e-mail address is not recognized, the data is sent to a protocol converter (at 710) and the telephone number is used to connect to the mobility gateway 26 (at line 712).

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. A system for routing instant messaging (IM) messages and short message service (SMS) messages within a communication network, the system comprising:
a first network element including a first destination parser module operative to analyze first destination data of an SMS message to determine if the first destination data is a telephone number and, if the first destination data is not a telephone number, processing the SMS message for transmission through a gateway for a data network; and,
a second network element including a second destination parser module operative to analyze second destination data of an IM message to determine if the second destination data is an e-mail address and, if the second destination data is not an e-mail address, processing the IM message for transmission through a gateway for a wireless network.

2. The system as set forth in claim 1 wherein the first network element is a switching element.

3. The system as set forth in claim 2 wherein the switching element is a mobile switching center.

4. The system as set forth in claim 1 wherein the second network element is a router.

5. The system as set forth in claim 1 wherein the first network element further includes a protocol converter operative to process the first message for transmission through the gateway for the data network.

6. The system as set forth in claim 1 wherein the second network element further comprises a protocol converter for processing the IM message for transmission through the gateway for the wireless network.

7. The system as set forth in claim 1 wherein the first network element is operative to process the SMS message for transmission through the wireless network if the destination data is a telephone number.

8. The system as set forth in claim 1 wherein the second network element is operative to process the IM message for transmission through the data network if the second destination data is an e-mail address.

9. A method for handling instant messaging (IM) messages and short message service (SMS) messages within a communication network, the method comprising steps of:
receiving an SMS message having destination data included therein;
analyzing the destination data to determine if the destination data is a telephone number; and,
processing the SMS message for transmission through a gateway for a data network if the destination data is not a telephone number.

10. The method as set forth in claim 9 further comprising processing the SMS message for transmission through a gateway for a wireless network if the destination data is a telephone number.

11. A method for routing instant messaging (IM) messages and short message service (SMS) messages within a communication network, the method comprising steps of:
receiving an IM message having destination data included within;
analyzing the destination data to determine if the destination data is an e-mail address; and,
processing the IM message for transmission through a gateway for a wireless network if the destination data is not an e-mail address.

12. The method as set forth in claim 11 further comprising processing the IM message for transmission through a gateway for a data network if the destination data is an e-mail address.

13. A system for handling instant messaging (IM) messages and short message service (SMS) messages within a communication network, the system comprising:
means for receiving an SMS message having destination data included therein;
means for analyzing the destination data to determine if the destination data is a telephone number; and,
means for processing the SMS message for transmission through a gateway for a data network if the destination data is not a telephone number.

14. The system as set forth in claim 9 further comprising means for processing the SMS message for transmission through a gateway for a wireless network if the destination data is a telephone number.

15. A system for routing instant messaging (IM) messages and short message service (SMS) messages within a communication network, the system comprising:
means for receiving an IM message having destination data included within;
means for analyzing the destination data to determine if the destination data is an e-mail address; and,
means for processing the IM message for transmission through a gateway for a wireless network if the destination data is not an e-mail address.

16. The system as set forth in claim 11 further comprising means for processing the IM message for transmission through a gateway for a data network if the destination data is an e-mail address.
